(19) United States
(12) Patent Application Publication
(10) Pub. No.: US 2002/0165634 A1
(43) Pub. Date: Nov. 7, 2002

(54) Fabrication of laminate tooling using closed-loop direct metal deposition

(76) Inventor: Timothy W. Skszek, Saline, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/116,197

(22) Filed: Apr. 3, 2002

Related U.S. Application Data
(63) Continuation-in-part of application No. 09/570,986, filed on May 15, 2000, now Pat. No. 6,410,105.
(63) Continuation-in-part of application No. 09/526,631, filed on Mar. 16, 2000.
(60) Provisional application No. 60/281,157, filed on Apr. 3, 2001.

(51) Int. Cl. G06F 19/00

(52) U.S. Cl. 700/118; 700/166

(57) ABSTRACT

A laser-assisted, direct metal deposition (DMD^{tm}), preferably in a closed-loop arrangement, is used to fabricate designed articles and components such as molds and tools with improved properties. A laminate substrate or structure is provided having a surface onto which a layer of a material is deposited having the desired characteristic using the laser-assisted DMD process. In different embodiments, the substrate/layer combination may be tailored for improved wear resistance, thermal conductivity, density/hardness, corrosion and/or resistance to corrosion, oxidation or other desirable effects. Alternatively, the layer of material may be tailored to have a phase which is different from that of the substrate. In particular, the layer material itself may be chosen to promote a phase which is different from that of the substrate. To enhance throughput, the outer layer(s) of material may be fabricated using a robotic closed-loop DMD arrangement. In concert with the improvements made possible through the laminate fabrication method, tailored outer layer(s), the method may further include the step of incorporating one or more conformal cooling channels within the component or the formation of one or more conductive heat sinks or thermal barriers during the DMD fabrication of the component itself.

### REFERENCE TO RELATED APPLICATIONS

This application claims priority from U.S. Provisional Patent Application Serial No. 60/281,157, filed Apr. 3, 2001; and is a continuation-in-part of co-pending U.S. patent application Ser. No. 09/570,986, filed May 15, 2000, which is a continuation-in-part of U.S. patent application Ser. No. 09/526,631, filed Mar. 16, 2000 and U.S. patent application Ser. No. 09/107,912, filed Jun. 30, 1998, now U.S. Pat. No. 6,122,564. The entire content of each of these applications is incorporated herein by reference.

### FIELD OF THE INVENTION

This invention relates generally to additive manufacturing and, in particular, to the use of a closed-loop, laser-based direct metal deposition (DMD^{tm}) process to fabricate tooling and other components featuring a laminated construction.

### BACKGROUND OF THE INVENTION

The desired functionality of dies, molds and three-dimensional components is a function of service conditions, the end application, and other considerations. Many of these components are expensive due to application requirements, including the need for high-strength, hard and temperature-resistant materials. The expense is often due to cost and delivery parameters associated with machining rates and raw material. The cost of tooling (i.e., molds and dies) has also prevented mass customization of cast or molded products for local markets.

The fabrication of three-dimensional components using a technique known as “laminated construction” is adaptable to various operating needs and has the potential of substantially reducing tooling costs and minimizing lead-time while providing improved heat transfer characteristics. This allows reduced process cycle times and productivity improvement, which results in a lower overall piece part cost. In particular, techniques such as closed-loop direct metal deposition and laser clad tailored surfaces can be utilized to design and tailor tool surfaces and components for specific applications, overcoming many of the barriers which limit the number of applications.

However, the fabrication of production tooling and components using a laminated construction technique has been limited due to the availability of materials, in sheet form, which possesses the physical and mechanical properties required to meet the specific application requirements. The inherent non-homogeneous characteristics associated with laminated construction process often times results in a “reads thru” condition, replicating the laminate profile onto the molded part surface, thus limiting the application of tooling and components fabricated using the laminated construction technique to prototype applications.

The application of a homogeneous material onto the surface of a tool or component fabricated using the laminated construction process provides the opportunity to fabricate a tool or component in a much shorter time period, with internal conformal-shaped heat transfer channels and reduced mass at a lower overall cost as compared to tooling manufactured using traditional methods from a homogeneous block of material. The technique will lead to cost and lead-time savings by reducing post processing cost and reconfiguring an existing tool.

Applications that require wear resistance or high temperature material properties often require the tool or component to be comprised of hard but brittle materials, whereas the overall component itself may require more ductile material for toughness during service life. A method of metallurgically bonding a brittle surface to a tough substrate should offer a wide array of choices for designers.

Temperature rise during operation is known to result in distortion due to material thermal expansion characteristics and metallurgical phase changes. Asymmetric thermal loading and resultant stress distribution and thermal fatigue contribute to the design life of a tool or component. The design life of a component increases with proper thermal management of the component. Temperature gradients, which exist within a mold or die during operation, significantly impact the dimensional characteristics of molded parts. The opportunity to cost effectively fabricate heat transfer channels which conform to the shape of the molding surface and provide the capability to locally vary the surface area and profile of the cooling channel can substantially improve the part quality and reduce the process cycle time to manufacture a molded component leading to increased profitability for the users of tooling or components

Lightweight materials, such as aluminum, are preferred for energy conservation, ease of handling, and improved thermal conductivity, but aluminum components often have poor wear resistance. A composite material laminate tool design, with thin hard surface and lighter interior will satisfy both energy conservation and increased service life due to reduced surface wear.

For large three-dimensional objects such as stamping tools, a reconfiguration method capable of localized processing on a stationary object has distinct advantages with respect to work handling and accuracy, which should lead to substantial cost savings. In such situations, a low-cost alloy can be used for the majority of the die, where load bearing is the key requirement, while a high-cost materials can be deposited strategically on to the low cost laminate material where wear, cutting, and abrasive action is needed to form the complex shape of metal-stamped parts.

### SUMMARY OF THE INVENTION

Broadly, this invention utilizes a laser-assisted, direct metal deposition (DMD^{tm}) process, preferably in a closed-loop arrangement, to fabricate articles and other components such as molds and tools with lower cost, improved material properties reduced delivery time.

According to the method, a laminate substrate is provided having a surface, onto which a layer of a material is deposited having the desired characteristic using the laser-assisted DMD process. In different embodiments, the substrate/layer combination may be tailored for improved wear resistance, thermal conductivity, density/hardness, corrosion and/or resistance to corrosion, oxidation or other undesirable effects.

In the preferred embodiment, a closed-loop, laser-assisted DMD process is deployed to add material to laminate substrate on an incremental basis. To enhance throughput, the substrate and/or outer layer(s) of material may be fabricated using a robotic closed-loop DMD arrangement. In concert with the improvements made possible through the tailored outer layer(s), the method may further include the step of incorporating one or more conformal cooling channels within the component or the formation of one or more conductive heat sinks or thermal barriers during the DMD fabrication of the component itself.

### BRIEF DESCRIPTION OF THE DRAWINGS

FIG. 1 shows a direct metal deposition (DMD) system having a stationary beam and moving substrate;

FIG. 2 is a close-up view of a deposition head and optical feedback monitoring system;

FIG. 3 illustrates a robotic DMD embodiment;

FIG. 4 illustrates how a DMD system may be improved with sensors and high-speed communications;

FIG. 5A shows an injection molding die incorporating conventional cooling channels; and

FIG. 5B shows an injection mold fabricated by the laminated process with a DMD-applied homogeneous molding surface and conformal cooling channels made possible through the method of this invention.

### DETAILED DESCRIPTION OF THE INVENTION

As described in U.S. Pat. No. 6,122,564, the entire contents of which are incorporated herein by reference, a closed-loop direct metal deposition (DMD®) process may be employed to fabricate three-dimensional components utilizing the tool path generated by a suitably equipped CAD/CAM package. A complex shape is generated by delivering desired material (i.e., metal/alloy powder, metal/ceramic mixture or wire) to a laser-melted pool, with a finished part being created by changing the relative position of the laser beam and the substrate. The system may use a stationary beam and material delivery system in conjunction with a moving substrate, or the beam and material delivery system may be moved relative to a stationary substrate.

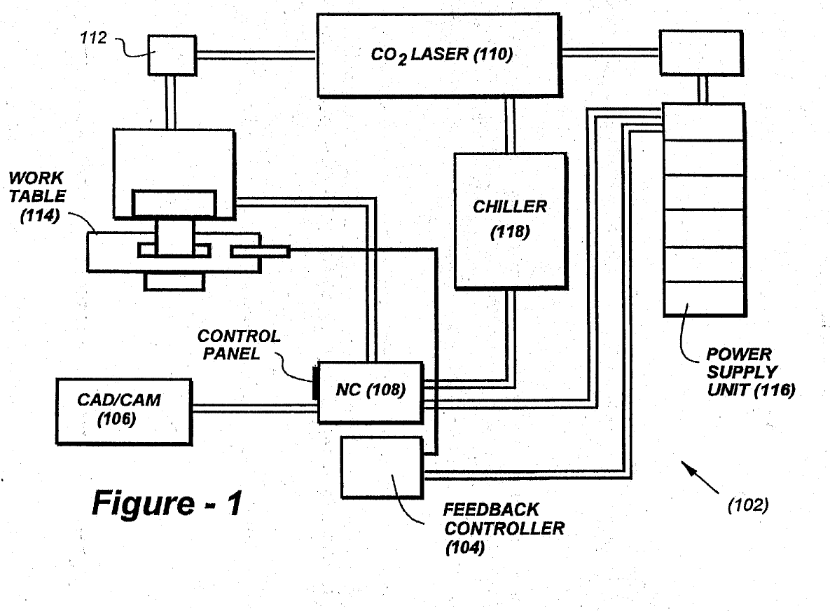

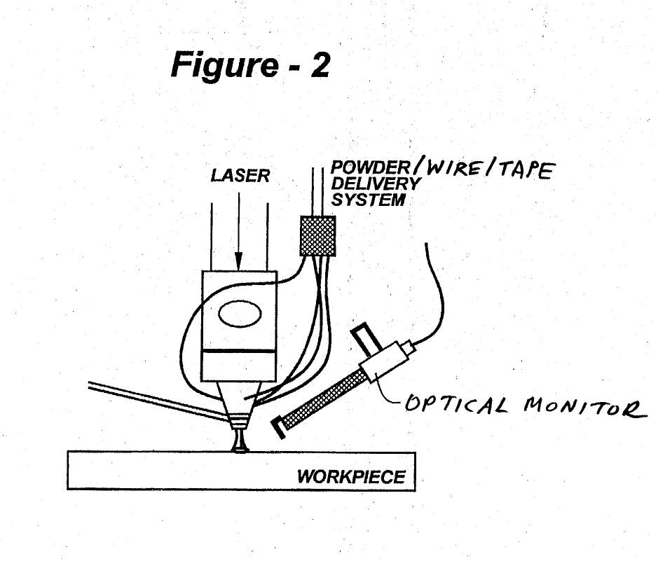

FIG. 1 shows a laser-aided, computer-controlled DMD system schematically at 10 being used to apply layers of material 20 on a substrate 30 to fabricate an object or cladding. The system is preferably equipped with feedback monitoring, better seen in FIG. 2, to control of the dimensions and overall geometry of the fabricated article. The geometry of the article is provided by a computer-aided design (CAD) system.

The deposition tool path is generated by a computer-aided manufacturing (CAM) system for CNC machining with post-processing software for deposition, instead of software for removal as in conventional CNC machining. CAM software interfaces with a feedback controller 104. These details of the laser-aided, computer controlled direct material deposition system can be found in U.S. Pat. No. 6,122,564, and are not all explicitly shown in FIGS. 1 and 2.

The factors that affect the dimensions of material deposition include laser power, beam diameter, temporal and spatial distribution of the beam, interaction time, and powder flow rate. Adequate monitoring and control of laser power, in particular, has a critical effect on the ability to fabricate completed parts and products with complex geometries and within control tolerances. Accordingly, the feedback controller 80 of the direct material deposition system typically cooperates directly with the numerical controller 90, which, itself, controls all functions of the direct material deposition system, including laser power.

The laser source 110 of the DMD system is mounted above the substrate 30 and a layer of material 20 is deposited according to the description of the object. The laser has sufficient power density to create a melt pool with the desired composition of substrate or previously deposited layer and cladding powder. The cladding powder, typically metallic or metallic/ceramic mixture, is sprayed on the substrate preferably through a laser spray nozzle with a concentric opening for the laser beam, as described in U.S. Pat. No. 4,724,299, so that the powder exits the nozzle co-axially with the beam.

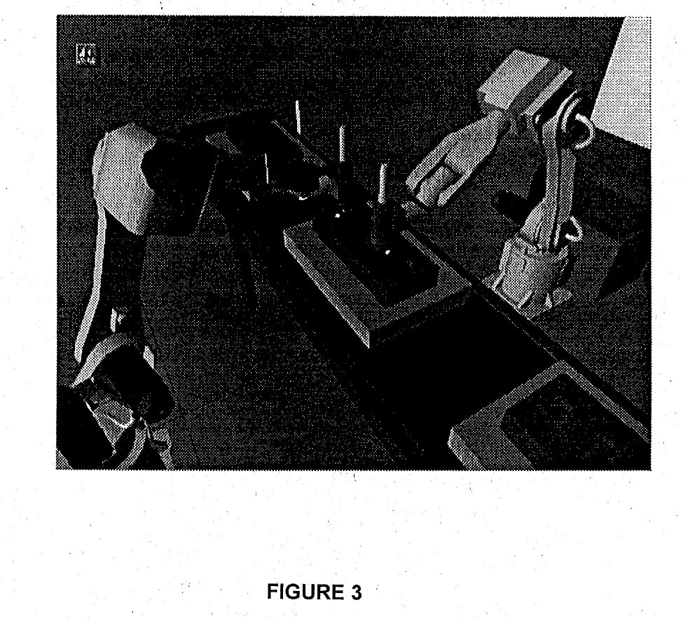

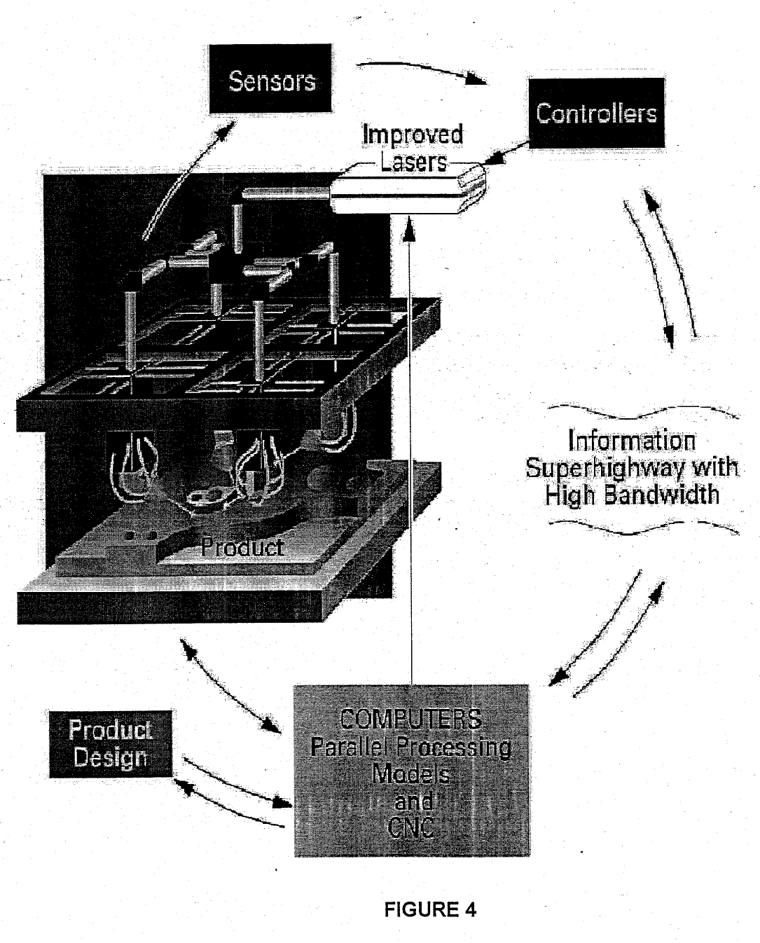

A numerical controller 108 controls all operating components of the DMD system of FIG. 1, including the operating conditions of the laser, receiving direction from the CAD/CAM system 106 for building the part or product. The numerical controller 108 also receives feedback control signals from the feedback controller 104 to adjust laser power output, and further controls the relative position of the substrate and laser spray nozzle. The CAD/CAM system 106 is equipped with software which enables it to generate a path across the substrate for material deposition. Other refinements, such as robotic handling and multiple deposition heads for simultaneous deposition onto a die surface, are depicted in FIGS. 3 and 4, respectively.

According to this invention, the closed-loop direct metal deposition (CLDMD) process is used to deposit desired alloys or metal alloy/ceramic materials on an existing surface of a die or other component to achieve a laminate structure. To satisfy a completely new design, or to change an existing design, the required area on the object can either be machined off to a desired shape and subsequently built over using CLDMD directly from the new CAD data or built over the existing surface, if the new design can accommodate it.

The optical feedback loop preferably maintains fabrication tolerances to within 25 to 150 microns. Material can be delivered at the laser melt pool by various mechanisms, including pneumatic powder delivery, wire feed or tape feed. Either the same material as the substrate or any other metallurgically compatible material can be deposited by this process. Through proper selection of the deposited material, properties can be tailored to a particular application in addition to geometric requirements. Surface oxidation during the process is minimized by inert shielding gas delivered either through the concentric nozzle or separate shielding nozzle. Under special circumstances, the process may be carried out in entirely within an inert atmosphere chamber.

With proper selection of the deposit alloy system, a functional component can be designed and fabricated using the laminated fabrication process to fabricate the substrate, with the opportunity to incorporate internal conformal shaped heat transfer channels, having a DMD applied surface of the laminate substrate, providing tailored properties such as a homogeneous material high polish or textured molding surface, improved wear resistance and resistance to thermal fatigue due to exposure to elevated temperature.

### Wear Resistance

Broadly, the preferred process includes the deposition of a Fe-based, Co-based, Ni-based, or a ceramic metal composite cermet material onto a lower cost, lightweight or thermally conductive laminate substrate composed of steel, aluminum or copper using the DMD process. The Fe, Co, Ni based alloy matrix provides the required strength and toughness, whereas the ceramic component or metastable phase will provide hard M₆C carbide phases. Fe—Cr—W—C carbon system has demonstrated that significantly better wear resistance compared to commercial alloys such as Stellite 6. When tested under the same conditions with a block on cylinder machine, scar width for Stellite 6 exceeded 1.5 mm whereas that for the designed alloy was below 0.5 mm.

### Thermal Management

The capability of the DMD process to provide a metallurgical bond between compatible yet dissimilar materials can also be utilized for improved thermal management of a tool or other components. Firstly, the laminate tool is fabricated using a low carbon steel alloy or a conductive material such as an aluminum or copper alloy. Secondly, heat transfer channels which conform to the surface profile of the tool or according to a preferred geometry and orientation can be incorporated within the laminate substrate leading to an increased rate of heat transfer during operation compared to presently used straight-line cooling channels for tooling or components used in thermoform or thermoset mold processes.

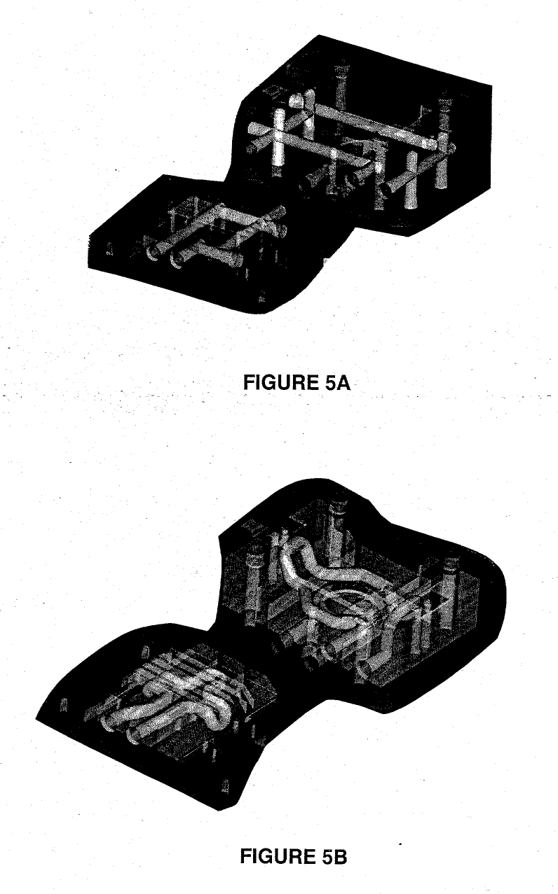

FIG. 5A shows an injection molding die with conventional heat transfer channels; FIG. 5B shows an injection mold with conformal-shaped heat transfer channels with a DMD-applied surface according to this invention. Improved thermal management can substantially reduce the cycle time and improve the quality of parts manufactured by thermoform or thermoset molding processes.

### Fabrication of Lightweight Laminate Components

The non-equilibrium synthesis capabilities of the DMD process may also be utilized to fabricate lightweight tools and other components in accordance with this invention. For example, a lightweight material such as an aluminum-alloy may be used as the laminate substrate, with a wear-resistant material or high-temperature material being deposited with desired geometry and properties for the working surface. In one embodiment, a cast aluminum-silicon substrate having a metallurgically bonded nickel alloy working surface is used for improved wear resistance. In this case the metallurgical bond also provides enhanced heat extraction. Another example is the integration of a steel working surface with an aluminum laminate substrate, either with conformal cooling channels or highly conductive heat sinks such as copper or aluminum clad graphite.

Reconfiguration of large laminate tools or components is a challenge due to their high mass, making accurate translation of the tool or component particularly difficult. For relatively flat surfaces, the problem can be overcome by moving the DMD optics system while keeping the tool stationary. However, if the laminate tool requires deposition on an inclined surface away from the line of sight of the laser, then moving optics on gantry system will not be effective. To meet these particular challenges, the robotic implementation of the moving system is proposed. As shown in FIG. 3, the beam and material can be delivered in almost in any position of the object, with a robot and the material delivery system mounted on its wrist. Such a system will increase the flexibility of CLDMD even further to process stationary three-dimensional objects and add features within at least a 270° work envelop around the object.

I claim:

1. A method of fabricating a component having improved properties, comprising the steps of:
a) providing a laminated substrate having a surface; and
b) depositing a layer of a material having a desired characteristic onto at least a portion of the surface of the laminate substrate using a laser-assisted direct metal deposition process.

2. The method of claim 1, wherein the layer of material exhibits improved wear or abrasion resistance relative to the laminate substrate.

3. The method of claim 1, wherein the layer of material has a thermal conductivity different from than that of the substrate.

4. The method of claim 1, wherein the layer of material exhibits improved elevated temperature material properties as compared to the laminate substrate.

5. The method of claim 1, wherein the layer of material has a different density than that of the substrate.

6. The method of claim 1, wherein the layer of material is more resistant to corrosion than the substrate.

7. The method of claim 1, wherein the layer of material is more resistant to oxidation than the substrate.

8. The method of claim 1, wherein the layer of material has a phase which is different from that of the substrate.

9. The method of claim 8, further including the step of choosing the material of the layer to promote a phase which is different from that of the substrate.

10. The method of claim 1, further including the step of dissolving a low-solubility material into the layer of material to enhance hardness, toughness, corrosion or oxidation resistance.

11. The method of claim 1, wherein the laminate substrate is itself fabricated using a direct metal deposition process.

12. The method of claim 1, wherein the laminate substrate and layer form part of a die, mold or other tool.

13. The method of claim 1, further including the step of robotically applying the layer of material.

14. A method of fabricating a component having improved properties, comprising the steps of:
a) providing a computer-aided design (CAD) description of the component to be fabricated;
b) using a laser-assisted, direct metal deposition (MD) process to fabricate a laminate structure in accordance with the CAD description; and
c) completing the component by depositing a layer of a material onto the structure using a laser-assisted, direct metal deposition (DMD) process, the layer of material providing at least one desired property when compared to the underlying laminate structure.

15. The method of claim 14, wherein the desired property is greater wear resistance.

16. The method of claim 14, wherein the desired property is a higher or lower thermally conductivity.

17. The method of claim 14, wherein the desired property is greater density.

18. The method of claim 14, wherein the desired property is increased resistance to corrosion.

19. The method of claim 14, wherein the desired property is greater resistance to oxidation.

20. The method of claim 14, wherein the layer of material has a phase which is different from that of the underlying laminate structure.

21. The method of claim 20, further including the step of choosing the material of the layer to promote a phase which is different from that of the substrate.

22. The method of claim 14, further including the step of dissolving a low solubility substance into the layer of material to enhance hardness, toughness, corrosion, or oxidation resistance.

23. The method of claim 14, wherein the component is a die, mold or other tool.

24. The method of claim 14, further including the step of applying the layer of material using a robotic closed-loop DMD arrangement.

25. The method of claim 14, further including the step of incorporating one or more conformal cooling channels within the component during its fabrication.

27. The method of claim 14, further including the step of incorporating one or more conductive heat sinks or thermal barriers during its fabrication.
